(19) United States
(12) Patent Application Publication
(10) Pub. No.: US 2010/0302788 A1
(43) Pub. Date: Dec. 2, 2010

(54) LIGHT EMITTING DIODE LAMP-SET

(76) Inventor: Chia-Cheng CHANG, Banciao City (TW)

Correspondence Address: Muncy, Geissler, Olds & Lowe, PLLC, 4000 Legato Road, Suite 310, FAIRFAX, VA, 22033, US

(21) Appl. No.: 12/473,574

(22) Filed: May 28, 2009

(51) Int. Cl. F21V 11/00; F21V 19/00

(52) U.S. Cl. 362/355; 362/382

(57) ABSTRACT

An LED lamp-set includes a lamp, which is a round-shape cap and an interior of which contains an LED holding slot to emplace an LED. A bottom of the lamp is connected and fixed with a lamp holder which can be made by a metallic material to dissipate heat generated by the LED. The lamp holder is provided with locking holes to lock the lamp and the LED on the lamp holder through locking elements. An outer rim of the lamp holder can be provided with lamp holder fixing holes to fix the lamp-set in a usage condition. A top end or an outer rim of the lamp can be provided additionally with a lamp shade to further improve versatility of application.

### BACKGROUND OF THE INVENTION

a) Field of the Invention

The present invention relates to an LED (Light Emitting Diode) lamp-set, and more particularly to an LED lamp-set which is able to achieve an illumination effect and is capable of being applied to various conditions of use.

b) Description of the Prior Art

Most lamp-sets and projecting lamps which have been widely used on markets in early days utilize halogen bulbs. Although being able to achieve the purpose of illumination, the halogen bulbs have already been weeded out under an existing situation that every product should save energy and reduce CO₂ (carbon dioxide) emission, as the halogen bulbs consume more electricity, generate heat easily and have a short lifetime of usage.

As continuous advancement of technologies, many existing vendors have researched to develop using LEDs as projecting lamp-sets for sources of illumination, wherein a low electricity consumption of the LEDs is employed to improve the shortcoming of the conventional halogen bulbs. However, although an LED unit of the LED lamp-set is provided with the advantages of energy-saving, environmental friendliness and a long lifetime of usage, an ordinary LED lamp is less resistant to heat than the conventional halogen bulb and is provided with an imperfect heat dissipation effect; hence, service temperature of the LED lamp will easily exceed an allowable setting, which results in attenuation of brightness and that a desired effect cannot be achieved. In addition, as the brightness of the LED lamp-set is still a little insufficient to totally replace the conventional halogen bulb, therefore, how to increase the illuminance of the LED remains an issue which needs to be overcome by many existing vendors.

### SUMMARY OF THE INVENTION

An LED lamp-set of the present invention includes a lamp, a lamp holder and a shade.

The lamp is a round-shape cap and an inner rim of the lamp can be processed by a glare treatment to achieve a light reflection effect, thereby increasing illuminance of an LED. A bottom of the lamp is provided with an LED holding slot to emplace the LED, and an outer rim at top of the lamp is provided with a groove ring to engage with the shade.

The lamp holder is provided at the bottom of the lamp and is made by a metallic material, such that heat generated by the LED can be dissipated through the lamp holder. The lamp holder is provided with plural locking holes to lock the lamp and the LED on the lamp holder through locking elements. An outer rim of the lamp holder can be provided with plural lamp holder fixing holes to fix the lamp-set in a usage condition.

The shade is a transparent material, and a color can be changed depending upon various conditions of use. Through providing different colors for the transparent shade, a color of light generated by the LED can be altered indirectly.

When a user operates, the lamp holder can be locked on a wall, and brightness of light generated by the LED will be improved through the glare treatment on the inner surface of the lamp, thereby achieving a requirement of illumination.

In addition to being used as described above, the outer rim of the lamp can be also covered by a lamp shade to form a chandelier which can be applied in a factory or a department store.

The aforementioned lamp shade or shade can be processed by an anti-glare treatment to increase comfortableness in use.

The primary object of the present invention is to form a chandelier for use, through providing the lamp shade on the outer rim of the lamp, thereby improving a range of application and complying with various requirements through the lamp shades of different shapes.

Another object of the present invention is to effectively improve the brightness of the LED, through the glare treatment on the inner surface of the lamp.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional exploded view of an LED lamp-set of the present invention.

FIG. 2 shows a three-dimensional schematic view of an LED lamp-set of the present invention, after being assembled.

FIG. 3 shows a schematic view of another embodiment of an LED lamp-set of the present invention.

FIG. 4 shows a schematic view of still another embodiment of an LED lamp-set of the present invention.

### DETAILED DESCRIPTION OF THE PREFERRED EMBODIMENTS

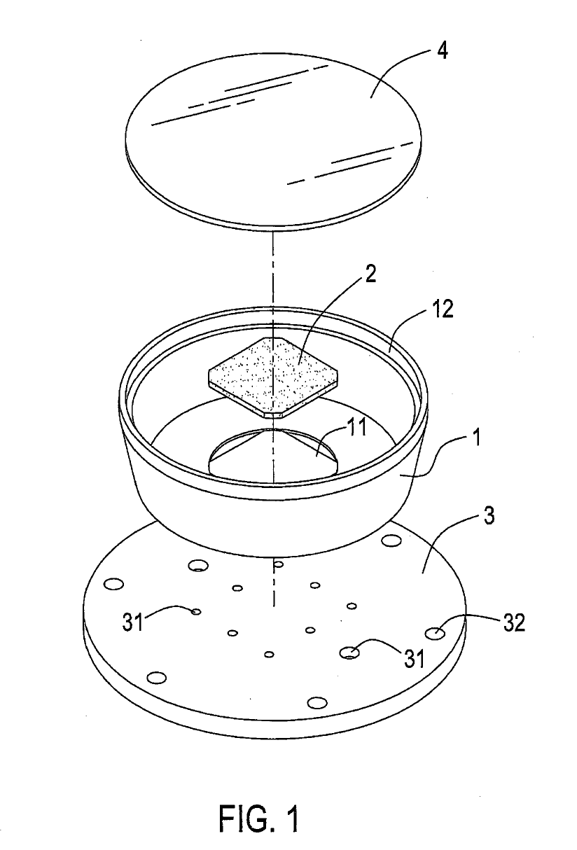

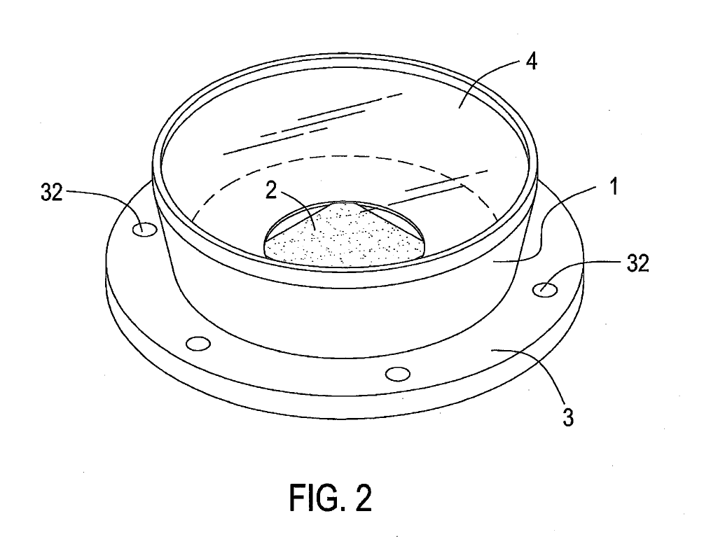

Referring to FIG. 1 and FIG. 2, it shows a three-dimensional exploded view of an LED lamp-set of the present invention and a three-dimensional schematic view of an LED lamp-set of the present invention, after being assembled. The LED lamp-set includes a lamp 1, a lamp holder 3 and a shade 4.

The lamp 1 is a round-shape cap to increase a light reflection effect and an inner rim of the lamp 1 can be processed by a glare treatment which can be sand blasting or electro-plating, in order to achieve the light reflection effect and increase illuminance of an LED 2. However, it should be noted that the aforementioned treatment methods are not fixed. A bottom of the lamp 1 is provided with an LED holding slot 11 to emplace the LED 2 which can be made into a chip-type structure. An outer rim at top of the lamp 1 is provided with a groove ring 12 to engage with the shade 4.

The lamp holder 3 is provided at a bottom of the lamp 1 and is made by a metallic material, such that heat generated by the LED 2 can be dissipated through the lamp holder 3. The lamp holder 3 is provided with plural locking holes 31 arranged in rings to lock the lamp 1 and the LED 2 on the lamp holder 3 through locking elements (not shown in the drawings). An outer rim of the lamp holder 3 can be surrounded by plural lamp holder fixing holes 32 to fix the lamp-set in a usage condition.

The shade 4 is a transparent material which can be made by glass or resin, and a color can be changed depending upon various conditions of use. Through providing different colors for the transparent shade 4, a color of light generated by the LED 2 can be altered indirectly.

When a user operates, he or she can lock the lamp holder 3 on a wall, and brightness of light generated by the LED 2 will be improved through the glare treatment on the inner surface of the lamp 1, thereby achieving a requirement of illumination.

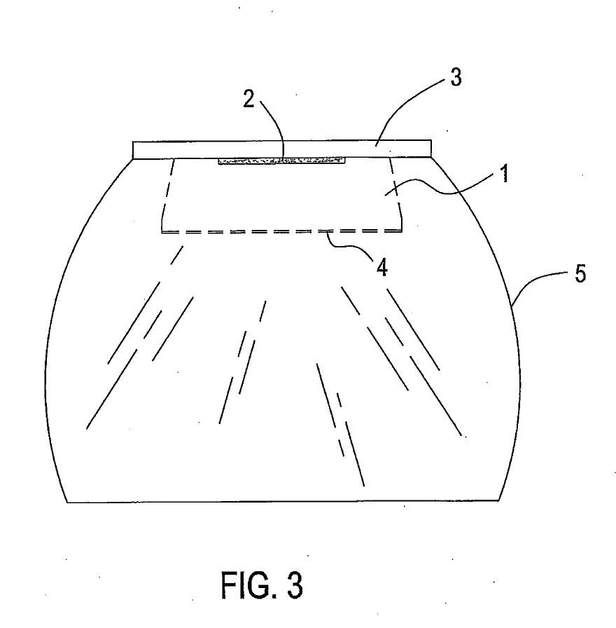

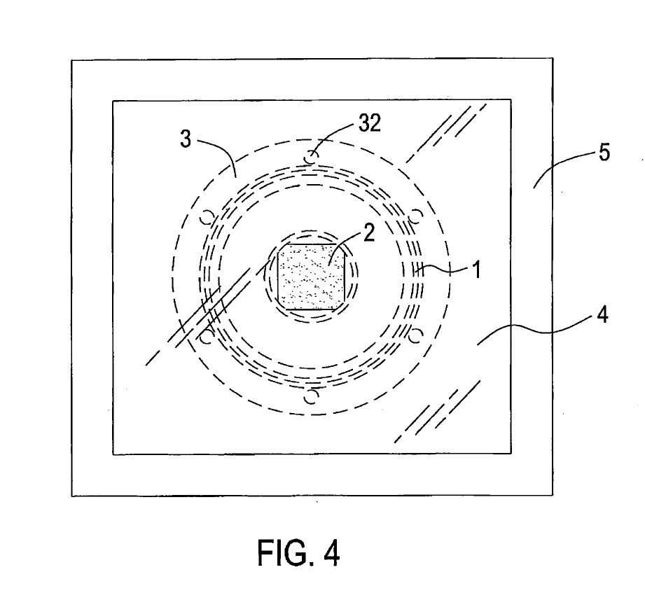

Referring to FIG. 3 and FIG. 4, it shows schematic views of embodiments of an LED lamp-set of the present invention. In addition to being used as described above, the outer rim of the lamp 1 can be also covered by a lamp shade 5 to form a chandelier which can be applied in a factory or a department store or can be used as a ceiling light steel rack lamp, thus further improving a range of application.

Whether for the shade 4 that is provided on the lamp 1 or the additional lamp shade 5, an anti-glare design can be carried out to increase comfortableness in use of illumination.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An LED (Light Emitting Diode) lamp-set comprising a lamp, a bottom of which is provided with an LED holding slot to emplace an LED; a lamp holder, which is provided at a bottom of the lamp, is made by a metallic material, is provided with locking holes to lock the lamp-set on the lamp holder, and an outer rim of which is surrounded by lamp holder fixing holes to fix the lamp-set for use.

2. The LED lamp-set according to claim 1, wherein an inner rim of the lamp is processed by a glare treatment.

3. The LED lamp-set according to claim 2, wherein the glare treatment is sand blasting or electro-plating.

4. The LED lamp-set according to claim 1, wherein an outer rim at top of the lamp is provided with a groove ring to engage with the shade.

5. The LED lamp-set according to claim 1, wherein the LED is a chip-type structure.

6. The LED lamp-set according to claim 1, wherein an exterior of the lamp is covered by a lamp shade.
